(19) United States
(12) Patent Application Publication
(10) Pub. No.: US 2024/0331385 A1
(43) Pub. Date: Oct. 3, 2024

(54) MONITORING SYSTEM, MONITORING APPARATUS, AND MONITORING METHOD

(71) Applicant: NEC Corporation, Minato-ku, Tokyo (JP)

(72) Inventors: Hayato Itsumi, Tokyo (JP); Koichi Nihei, Tokyo (JP); Yusuke Shinohara, Tokyo (JP); Takao Onomura, Tokyo (JP); Yutaka Takei, Tokyo (JP)

(73) Assignee: NEC Corporation, Minato-ku, Tokyo (JP)

(21) Appl. No.: 18/291,374

(22) PCT Filed: Jul. 29, 2021
(86) PCT No.: PCT/JP2021/028169

§ 371 Date: Jan. 23, 2024

(51) Int. Cl. G06V 20/52; G06V 20/40; G06V 20/56

(52) U.S. Cl. CPC G06V 20/52; G06V 20/44; G06V 20/56

(57) ABSTRACT

A state analysis unit analyzes the state of each of a plurality of monitoring targets based on sensor data received from the plurality of monitoring targets, and determines whether or not a predetermined event has occurred in each of the monitoring targets. A surveillant allocation unit determines one of the plurality of surveillants who is responsible for work of monitoring the monitoring target where it has been determined that the predetermined event has occurred based on the predetermined event that has occurred and a load index indicating the monitoring work by the surveillant.

### TECHNICAL FIELD

The present disclosure relates to a monitoring system, a monitoring apparatus, and a monitoring method.

### BACKGROUND ART

As related art, Patent Literature 1 discloses a remote control system of a working vehicle. The remote control system disclosed in Patent Literature 1 includes vehicle control apparatuses mounted on respective working vehicles and a remote operation apparatus that is located in the outside of the working vehicles. The working vehicles are configured in such a way that its traveling mode can be switched between an autonomous traveling mode and a remote control traveling mode. In the autonomous traveling mode, the vehicle control apparatus autonomously travels the working vehicle along a set traveling path. In the remote control traveling mode, the vehicle control apparatus travels the working vehicle according to an instruction including steering control received from the remote operation apparatus.

The remote operation apparatus controls the traveling mode in each of the plurality of working vehicles in accordance with an operation performed by a remote operator. The remote operation apparatus controls setting of the traveling mode in such a way that the number of working vehicles set to the remote control traveling mode concurrently is no more than one. When, for example, one working vehicle is set to the remote control traveling mode, the remote operation apparatus disables an operation for selecting another working vehicle and does not transmit an instruction for setting the remote control traveling mode to another working vehicle.

As another related technique, Patent Literature 2 discloses an information processing system used for monitoring of vehicles. In the information processing system disclosed in Patent Literature 2, a server acquires vehicle information from a vehicle, which is a target to be monitored by a surveillant. The server determines a monitoring priority level of a vehicle according to a degree of need for monitoring of the vehicle by the surveillant based on the acquired vehicle information. The monitoring priority levels are expressed, for example, in three levels of “high”, “medium”, and “low”. The server generates presentation information for monitoring of the vehicle based on the monitoring priority level and causes a display device to display the presentation information. The server displays, for example, an image acquired from a vehicle whose monitoring priority level is high in such a way that the size of this image is larger than images acquired from vehicles whose monitoring priority levels are lower than the above one.

### CITATION LIST

### Patent Literature

[Patent Literature 1] Japanese Unexamined Patent Application Publication No. 2021-36796

[Patent Literature 2] Japanese Unexamined Patent Application Publication No. 2020-61120

### SUMMARY OF INVENTION

### Technical Problem

In Patent Literature 1, the remote operator is able to monitor a plurality of working vehicles, for example, four working vehicles, and remotely operate one of them. However, in Patent Literature 1, a plurality of working vehicles are fixedly allocated to the remote operator. In Patent Literature 1, the mode of only one of the plurality of working vehicles can be set to the remote control mode. Therefore, even when an event that needs to be handled has occurred in one working vehicle while this remote operator is remotely operating another working vehicle in the remote control mode, the remote operator cannot remotely operate this working vehicle.

Patent Literature 2 discloses selecting, when there are a plurality of surveillants, one of them according to a status occurred in the vehicle. Assume, for example, that a surveillant A has a lot more experience in handling a situation of “occurrence of an accident” than a surveillant B. In this case, the server sets the priority level of “occurrence of an accident” in the surveillant A to be higher than the priority level of “occurrence of an accident” in the surveillant B. In this case, of the surveillant A and B, the surveillant A who can smoothly respond to status information of the vehicle may be caused to monitor this vehicle.

However, in Patent Literature 2, if the situation of the “occurrence of an accident” has occurred continuously, it is the surveillant A who will handle the situation of the “occurrence of an accident”. Therefore, in Patent Literature 2, a lot of monitoring work with high monitoring loads may be concentrated on certain surveillants. This problem may also occur not only in monitoring of vehicles but also in monitoring of other monitoring targets.

In view of the aforementioned circumstances, an aim of the present disclosure is to provide a monitoring system, a monitoring apparatus, and a monitoring method capable of appropriately distributing, when a surveillant who is responsible for detailed monitoring work of monitoring a specific monitoring target is determined from among a plurality of surveillants, loads of monitoring work among a plurality of surveillants.

### Solution to Problem

In order to attain the above object, the present disclosure provides a monitoring apparatus as a first aspect. The monitoring apparatus includes: information reception means for receiving one or more pieces of sensor data from each of a plurality of monitoring targets: state analysis means for analyzing the state of each of the plurality of monitoring targets based on the sensor data and determining whether or not a predetermined event has occurred in each of the monitoring targets: surveillant state management means for managing, regarding each of a plurality of surveillants who monitor at least one of the plurality of monitoring targets, a load index indicating labor of monitoring work; and surveillant allocation means for determining, when it is determined in the state analysis means that the predetermined event has occurred in one or more of the monitoring targets, one of the plurality of surveillants who is responsible for work of monitoring the monitoring target where it has been determined that the predetermined event has occurred based on the predetermined event that has occurred and the load index.

The present disclosure provides a monitoring system as a second aspect.

The monitoring system includes a monitoring apparatus used to monitor a plurality of monitoring targets and a plurality of sensors configured to acquire sensor data of the plurality of monitoring targets. The monitoring apparatus includes: information reception means for receiving sensor data from the plurality of sensors; state analysis means for analyzing the state of each of the plurality of monitoring targets based on the sensor data and determining whether or not a predetermined event has occurred in each of the monitoring targets: surveillant state management means for managing, regarding each of a plurality of surveillants who monitor at least one of the plurality of monitoring targets, a load index indicating labor of monitoring work; and surveillant allocation means for determining, when it is determined in the state analysis means that the predetermined event has occurred in one or more of the monitoring targets, one of the plurality of surveillants who is responsible for work of monitoring the monitoring target where it has been determined that the predetermined event has occurred based on the predetermined event that has occurred and the load index. The present disclosure provides a monitoring method as a third aspect. The monitoring method includes: receiving one or more pieces of sensor data from each of a plurality of monitoring targets: analyzing the state of each of the plurality of monitoring targets based on the sensor data and determining whether or not a predetermined event has occurred in each of the monitoring targets; and determining, when it is determined that the predetermined event has occurred in one or more of the monitoring targets, a surveillant who is responsible for work of monitoring the monitoring target where it has been determined that the predetermined event has occurred from among the plurality of surveillants who monitor at least one of the plurality of monitoring targets based on the predetermined event that has occurred and a load index indicating labor of monitoring work of a surveillant.

### Advantageous Effects of Invention

A monitoring system, a monitoring apparatus, and a monitoring method according to the present disclosure are able to appropriately distribute loads of monitoring work among a plurality of surveillants.

### BRIEF DESCRIPTION OF DRAWINGS

FIG. 1 is a block diagram showing a monitoring system according to a first example embodiment of the present disclosure;

FIG. 2 is a block diagram showing a configuration example of a monitoring apparatus:

FIG. 3 is a diagram showing one example of information on each surveillant managed by a surveillant state management unit:

FIG. 4 is a diagram showing another example of the information on each surveillant managed by the surveillant state management unit:

FIG. 5 is a flowchart showing an operation procedure in the monitoring apparatus:

FIG. 6 is a block diagram showing a monitoring system according to a second example embodiment of the present disclosure:

FIG. 7 is a block diagram showing a configuration example of a mobile body:

FIG. 8 is a block diagram showing a configuration example of a remote monitoring apparatus:

FIG. 9 is a diagram showing one example of an overall monitoring screen according to the second example embodiment;

FIG. 10 is a diagram showing one example of a detailed monitoring screen according to the second example embodiment:

FIG. 11 is a block diagram showing a monitoring system according to a third example embodiment of the present disclosure;

FIG. 12 is a block diagram showing a configuration example of the monitoring apparatus;

FIG. 13 is a diagram showing one example of an overall monitoring screen according to the third example embodiment:

FIG. 14 is a diagram showing one example of a detailed monitoring screen according to the third example embodiment; and

FIG. 15 is a block diagram showing a configuration example of a computer apparatus.

### EXAMPLE EMBODIMENT

Hereinafter, example embodiments of the present disclosure will be described in detail with reference to the drawings. Note that the following descriptions and the drawings are omitted and simplified as appropriate for the sake of clarification of the description. Throughout the drawings, the same symbols are attached to the same or similar elements and overlapping descriptions are omitted as necessary.

FIG. 1 shows a monitoring system according to a first example embodiment of the present disclosure. A monitoring system 100 includes a monitoring apparatus 110 and a plurality of sensors 130. The monitoring apparatus 110 is an apparatus that is used to monitor a plurality of monitoring targets. The monitoring target may be, for example, a mobile body such as an automobile, a bus, construction equipment, or a working vehicle, or may be a site such as a road or a construction site. In this example embodiment, the number of surveillants may be smaller than the number of monitoring targets.

Each of the plurality of monitoring targets includes one or more sensors 130. Each sensor 130 acquires sensor data of the monitoring target. Each sensor 130 is connected to, for example, the monitoring apparatus 110 via, for example, a wireless communication network, a wired communication network, or a combination thereof. Each sensor 130 outputs the sensor data to the monitoring apparatus 110. The sensor 130 may include an image-capturing device such as a camera that acquires images. The sensor 130 may include a sensor that outputs information on the state of the monitoring target. When, for example, the monitoring target is a mobile body, the plurality of sensors 130 may include an image-capturing device mounted on the mobile body, and sensors for measuring the speed, the acceleration, and the steering angle of the mobile body. The sensor 130 may be an image-capturing device that outputs a video image that includes the monitoring target as a subject.

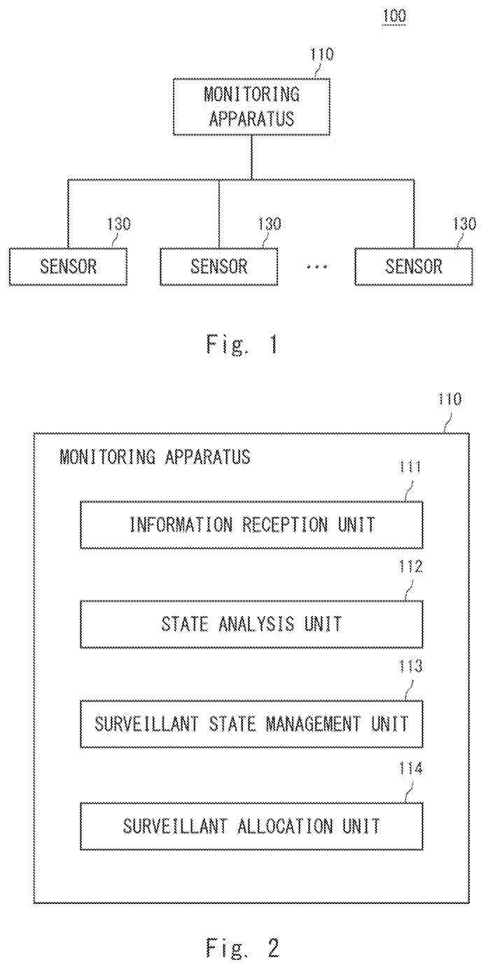

FIG. 2 shows a configuration example of the monitoring apparatus 110. The monitoring apparatus 110 includes an information reception unit 111, a state analysis unit 112, a surveillant state management unit 113, and a surveillant allocation unit 114. The monitoring apparatus 110 may be formed, for example, as a computer device including hardware including one or more processors and one or more memories. At least some of the functions of the respective parts in the monitoring apparatus 110 may be implemented by one or more processors operating according to the program loaded from one or more memories.

The information reception unit (information reception means) 111 receives sensor data from the plurality of sensors 130 (see FIG. 1). In other words, the information reception unit 111 receives one or more pieces of sensor data from each of a plurality of monitoring targets. When, for example, the monitoring targets are mobile bodies, the information reception unit 111 receives images captured by the image-capturing device from each of the mobile bodies. Further, the information reception unit 111 receives information on the speed, the acceleration, and the steering angle from each mobile body. The plurality of mobile bodies, which are monitoring targets, may include an autonomous driving vehicle that performs autonomous traveling. In this case, the information reception unit 111 may receive information on autonomous driving. When the monitoring target is a construction site, the information reception unit 111 may receive an image of the site where working is performed. The monitoring target may be a working vehicle such as a heavy machine in a construction site. In this case, the information reception unit 111 may receive a video image that includes the working vehicle as a subject.

The state analysis unit (state analysis means) 112 analyzes the state of each of the plurality of monitoring targets based on the received sensor data, and determines whether or not a predetermined event has occurred in each monitoring target. The predetermined event includes, for example, an event that needs to be carefully monitored by a surveillant. The predetermined event may include an event that needs to be handled by a surveillant. When, for example, the monitoring target is a mobile body, the state analysis unit 112 determines whether or not there is an event which requires careful monitoring of the mobile body. When the mobile body is a vehicle that can perform autonomous traveling, the state analysis unit 112 may determine whether or not there is an event that needs to be handled or instructed by the surveillant in the mobile body. The event that needs to be handled by the surveillant includes, for example, an event in which it is difficult for the vehicle to drive on its own, such as a case where a vehicle that can perform autonomous traveling overtakes another vehicle or a case where it restarts driving after a temporary stop. When the monitoring target is a construction site, the state analysis unit 112 may determine whether or not there is an event which requires careful monitoring of the construction site. For example, the state analysis unit 112 may determine whether or not there is a person who is approaching the working vehicle in the construction site. Further, the state analysis unit 112 may determine whether or not the work is performed in a predetermined order or whether or not the work is performed by a predetermined number or more of people.

The state analysis unit 112 may further calculate an importance of monitoring a predetermined event that has occurred in a monitoring target. The importance of monitoring is, for example, an index indicating the importance level of monitoring. When, for example, a serious accident may occur or an immediate action needs to be taken if a surveillant has failed to carefully monitor a predetermined event, the importance of monitoring is set to high. On the other hand, if no serious accident occurs even when there is some missing in the monitoring or if there is no problem even when it takes time before any action is taken, the importance of monitoring is set to low. The state analysis unit 112 determines the importance of monitoring according to, for example, a predetermined event that has occurred in the monitoring target. When, for example, the occurred event is overtaking of a vehicle, the importance of monitoring may be set to high. On the other hand, when the occurred event is restarting of driving after a temporary stop, the importance of monitoring may be set to low. The importance of monitoring may be calculated, for example, from scores that correspond to events in advance. For example, one point is given to handling of an event of restarting driving from a state in which it stops, three points are given to handling of an event occurring in a pedestrian crossing, and five points are given to handling of an event of overtaking. In this manner, the importance of monitoring may be determined from the score that corresponds to the occurred event. The state analysis unit 112 may change the importance of monitoring depending on the situation of the monitoring target when a predetermined event has occurred. For example, when an event occurs on a road where there are many people, five points are given. On the other hand, when an event occurs on a straight road with good visibility, one point is given. This point may be added to the above score determined according to the content of the event. When, for example, the monitoring target is a mobile body, the state analysis unit 112 may calculate the importance of monitoring in accordance with the number of passengers in the mobile body, the situation of the road on which the mobile body is traveling (an arterial road, a residential area or the like), or a combination thereof. When, for example, the occurred event is overtaking of a vehicle and this event has occurred on a busy road, the importance of monitoring may be set to high. On the other hand, when the occurred event is overtaking of a vehicle and this event has occurred on a straight road with good visibility, the importance of monitoring may be set a little lower.

The surveillant state management unit (surveillant state management means) 113 manages, for each of the plurality of surveillants who monitor at least one of a plurality of monitoring targets, a load index indicating the labor of the monitoring work. The surveillant state management unit 113 manages, for example, the labor of the monitoring work performed in a predetermined period, such as the day when the monitoring is conducted or one week as a load index. The load index may be determined, for example, according to a total time during which a surveillant has performed detailed monitoring work (total monitoring time), the number of times that the surveillant has performed detailed monitoring work (total number of times in charge), a total value of importance of the detailed monitoring work (total importance of monitoring), or a combination thereof.

Each criterion of the above load index may be managed by a unit, such as the number of times, a time, or the like, that corresponds to the criterion, or ranges of values may be defined in advance and may be managed as levels. For example, the total monitoring time of one to three hours may be defined to be “low”, four to six hours may be defined to be “medium”, and seven or more hours may be defined to be “high”. When the total monitoring time of a surveillant A is four hours, the level of the total monitoring time of the surveillant A may be managed as “medium”. Alternatively, for example, the total number of times in charge of 1 to 10 times may be defined to be “small”, 11 to 20 times may be defined to be “normal”, and 21 or more times may be defined to be “large”. When the total number of times in charge of a surveillant B is 15, the total number of times in charge of the surveillant B may be managed as “normal”.

Further, the level may be given for each criterion or may be determined according to combinations. When, for example, the total monitoring time of the surveillant C is “high” and the total number of times in charge is “high”, the load index of the surveillant C may be managed as “high”. On the other hand, when the total monitoring time of the surveillant D is “small” and the total number of times in charge is “small”, the load index of the surveillant C may be managed as “low”.

When it is determined in the state analysis unit 112 that a predetermined event has occurred in one or more of the monitoring targets, the surveillant allocation unit (surveillant allocation means) 114 determines the surveillant who is responsible for the detailed monitoring work of monitoring the monitoring target where it has been determined that a predetermined event has occurred. At this time, the surveillant allocation unit 114 determines one of the plurality of surveillants who is responsible for the detailed monitoring work based on the predetermined event that has occurred and the load index of each surveillant.

The surveillant allocation unit 114 determines the surveillant who is responsible for the detailed monitoring work in such a way that, for example, the detailed monitoring work is appropriately distributed among a plurality of surveillants and the load indices are equalized. In other words, the surveillant allocation unit 114 determines the surveillant who is responsible for the detailed monitoring work in such a way that detailed monitoring work is not concentrated on certain surveillants. For example, the surveillant allocation unit 114 may compare total monitoring times of the plurality of surveillants, and allocate detailed monitoring work to a surveillant whose total monitoring time is short. Alternatively, the surveillant allocation unit 114 may allocate detailed monitoring work to a surveillant whose total number of times in charge is small. The surveillant allocation unit 114 may allocate detailed monitoring work to a surveillant whose total value of importance of monitoring is small.

When it is determined that predetermined events have occurred in a plurality of monitoring targets, the surveillant allocation unit 114 may determine surveillants who are responsible for the monitoring work in a descending order of the importance of monitoring. Assume, for example, that two predetermined events with different importance of monitoring have occurred. In this case, the surveillant allocation unit 114 first determines the surveillant who is responsible for the detailed monitoring work of handling a predetermined event with a high importance of monitoring. For example, the surveillant allocation unit 114 allocates detailed monitoring work with high importance of monitoring to the surveillant whose total monitoring time is the shortest. Next, the surveillant allocation unit 114 determines the surveillant who is responsible for the detailed monitoring work of handling a predetermined event with a low importance of monitoring. For example, the surveillant allocation unit 114 allocates detailed monitoring work with a low importance of monitoring to the surveillant whose total monitoring time is the second shortest.

The surveillant state management unit 113 may further manage monitoring work for which each surveillant can be responsible. For example, the surveillant state management unit 113 manages, regarding one surveillant, information indicating that he/she can be responsible for detailed monitoring work in a case where an event A has occurred and detailed monitoring work in a case where an event B has occurred. Further, the surveillant state management unit 113 manages, regarding another surveillant, information indicating that he/she can be responsible for detailed monitoring work in a case where the event B has occurred and detailed monitoring work in a case where an event C has occurred. The surveillant allocation unit 114 may specify, by using information on the monitoring work for which each surveillant can be responsible, one or more of the plurality of surveillants who is/are responsible for work of monitoring the monitoring target where it has been determined that a predetermined event has occurred. The surveillant allocation unit 114 may determine, based on the predetermined event that has occurred and the load index of each surveillant, the surveillant who is responsible for the detailed monitoring work from among the one or more surveillants that have been specified.

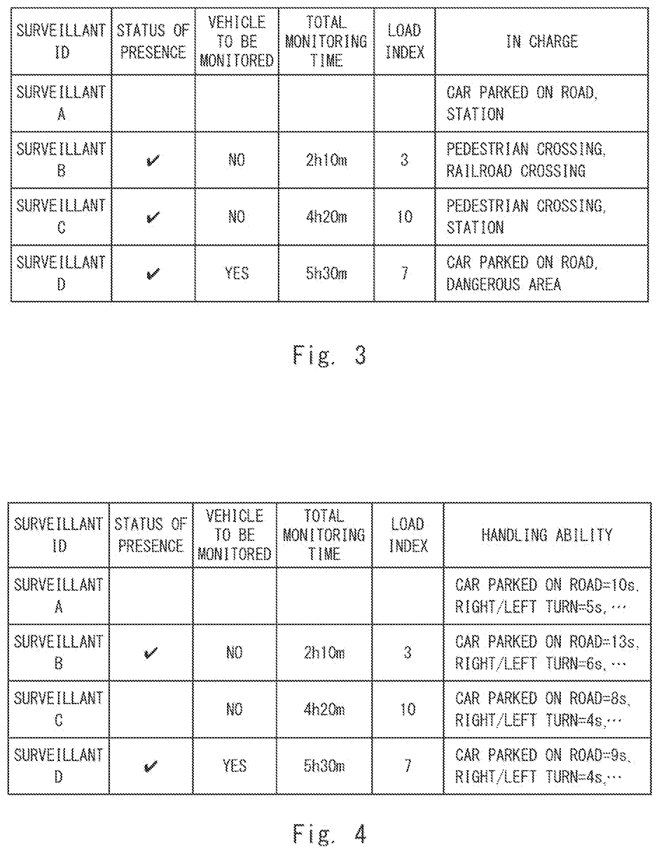

FIG. 3 shows one example of information on each surveillant managed by the surveillant state management unit 113. For example, the surveillant state management unit 113 manages, for each surveillant, information on “status of presence”, “vehicle to be monitored”, “total monitoring time”, “load index”, and “in charge”. The “status of presence” indicates whether or not a surveillant is present, that is, whether or not this surveillant is able to perform the monitoring work. The “vehicle to be monitored” indicates a mobile body regarding which the surveillant is performing detailed monitoring work. The “total monitoring time” indicates the time during which the surveillant has executed the detailed monitoring work. The “load index” indicates the load index of the monitoring work. The information “in charge” indicates the monitoring work for which the surveillant can be responsible. For example, when there is an event that needs to be handled in a pedestrian crossing, the surveillant allocation unit 114 determines, of the surveillants B and C who can be responsible for an event that has occurred in a pedestrian crossing, the surveillant C with low load index as a person who is responsible for the event that has occurred in the pedestrian crossing.

The surveillant state management unit 113 may further manage a handling ability of each surveillant to handle predetermined events in the aforementioned detailed monitoring work. For example, the surveillant state management unit 113 manages, for each surveillant and for each predetermined event, a handling time indicating a time from the start of the detailed monitoring work to the end of this work as the handling ability. Specifically, the surveillant state management unit 113 may manage, regarding the surveillant A, a time from when the surveillant A has started the detailed monitoring work for handling the event A to when he/she ends this work as the handling ability for the event A.

Alternatively, the surveillant state management unit 113 may manage, for each surveillant and for each predetermined event, the number of times the detailed monitoring work is allocated as the handling ability. The surveillant allocation unit 114 may determine the surveillant who is responsible for the detailed monitoring work based on the handling ability of each surveillant in addition to the load index of each surveillant. In this case, the surveillant allocation unit 114 may determine, regarding one event, for example, a surveillant who can quickly handle this event as a person who is responsible for the detailed monitoring work.

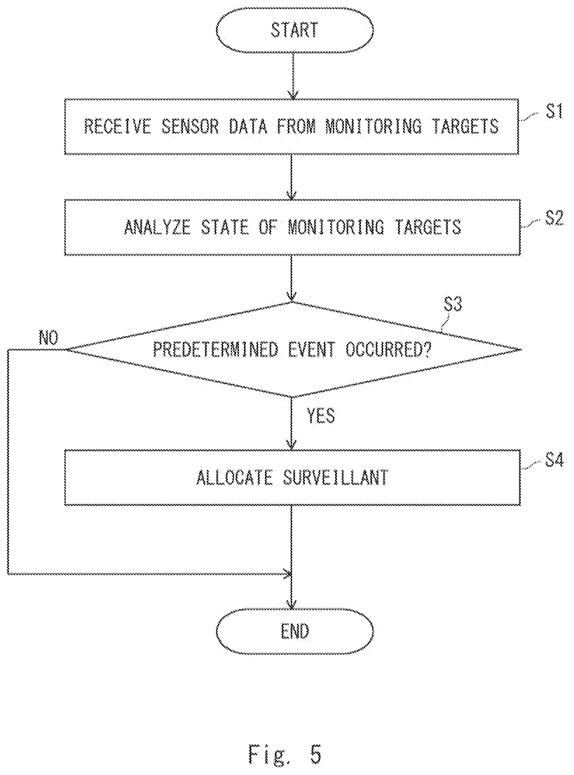

FIG. 4 shows another example of the information on each surveillant managed by the surveillant state management unit 113. The surveillant state management unit 113 manages, for each surveillant, information on “status of presence”, “vehicle to be monitored”, “total monitoring time”, “load index”, and “handling ability”. In FIG. 4, the “handling ability” indicates a time from when each surveillant has started the detailed monitoring work of handling a predetermined event to when he/she ends this work for handling the predetermined event. When, for example, an event that needs to be handled to achieve right/left turn has occurred, the surveillant allocation unit 114 determines, of the surveillant B and the surveillant D who can handle this event, the surveillant D who has handled the same kind of event relatively quickly in the past as a person who is responsible for the event that needs to be handled to achieve right/left turn.

In the aforementioned description, it has been described that the surveillant allocation unit 114 determines the surveillant depending on any one of information items held by the surveillant state management unit 113 and the load index at the time of determination of the surveillant who is responsible for the detailed monitoring work of monitoring the monitoring target where it has been determined that a predetermined event has occurred. However, this example embodiment is not limited to this. For example, the surveillant allocation unit 114 may determine the surveillant who is responsible for the detailed monitoring work of monitoring the monitoring target depending on the plurality of information items held by the surveillant state management unit 113 and the load index. For example, the surveillant allocation unit 114 may determine the surveillant who is responsible for the monitoring work depending on the type of the detailed monitoring work of the monitoring target, such as a pedestrian crossing or a station, the handling ability, and the total monitoring time.

Further, while values are described regarding the information items managed by the surveillant state management unit 113 in the above description, this example embodiment is not limited to this configuration. For example, the surveillant state management unit 113 may instead manage these information items in each item by classifying them into levels according to whether they are higher or lower than criteria.

The monitoring apparatus 110 may further include a monitoring screen display unit (monitoring screen display means). The monitoring screen display unit controls screen display in a plurality of display devices (not shown) used by a plurality of surveillants. The surveillant allocation unit 114 notifies the monitoring screen display unit of information on the surveillant determined to be responsible for the monitoring work. The surveillant allocation unit 114 notifies the screen display unit of information such as, for example, the name of the surveillant, the identification information (ID: Identifier), the seat number, the identification number of the display device used by this surveillant, and the Internet Protocol (IP) address as the information on the determined surveillant. The monitoring screen display unit displays, on one of the plurality of display devices that is used by the surveillant determined by the surveillant allocation unit 114, one or more pieces of sensor data received from the monitoring target where it has been determined that a predetermined event has occurred. The monitoring screen display unit displays, for example, the image of the monitoring target on the display device. The surveillant performs detailed monitoring work of monitoring the monitoring target where it has been determined that a predetermined event has occurred while checking the video image displayed on the display device. The surveillant remotely controls the monitoring target as necessary.

When the surveillant has performed the detailed monitoring work, the surveillant state management unit 113 updates the load index of this surveillant according to the importance of monitoring calculated by the state analysis unit 112. For example, the surveillant state management unit 113 updates the load index by adding a value according to the importance of monitoring to the load index of the surveillant who has performed the detailed monitoring work. Further, when the surveillant has performed the detailed monitoring work, the surveillant state management unit 113 updates items related to this monitoring work such as, for example, the handling ability (handling time or the like required for this monitoring work) or the total monitoring time.

The monitoring screen display unit may display a first monitoring screen for monitoring the plurality of entire monitoring targets and a second monitoring screen for specifically monitoring a monitoring target where a predetermined event has occurred on the display device. The first monitoring screen may include an area that displays sensor data received from the plurality of monitoring targets. The first monitoring screen may include an area for sending a notification of a predetermined event determined by the state analysis unit 112 to be occurring. The second monitoring screen includes an area that displays sensor data received from a specific monitoring target. For example, the second monitoring screen displays only sensor data received from a specific monitoring target. Alternatively, the second monitoring screen may display sensor data of a specific monitoring target in such a way that its size becomes relatively larger than that of sensor data of other monitoring targets.

When it is not determined in the state analysis unit 112 that a predetermined event has occurred in one or more of the monitoring targets, the monitoring screen display unit may display the first monitoring screen on the display device. For example, the monitoring screen display unit may cause each of one or more display devices individually used by each surveillant to display the first monitoring screen to cause the plurality of surveillants to monitor a plurality of monitoring targets. Alternatively, the monitoring screen display unit may cause a large-sized display device commonly used by the plurality of surveillants to display the first monitoring screen and cause the plurality of surveillants to monitor the plurality of monitoring targets.

When it is determined that a predetermined event has occurred and a surveillant who is responsible for the detailed monitoring work has been determined in the surveillant allocation unit 114, the monitoring screen display unit may cause one or more display devices individually used by this surveillant to display a second monitoring screen. The surveillant checks a video image or the like of the monitoring target where it has been determined that a predetermined event has occurred, the video image being displayed on the display device, thereby executing detailed monitoring work of this monitoring target. The monitoring screen display unit may cause the display device used by another surveillant to display the first monitoring screen and cause this surveillant to monitor a plurality of monitoring targets.

Next, an operation procedure will be described. FIG. 5 shows an operation procedure (monitoring method) in the monitoring apparatus 110. In the monitoring apparatus 110, the information reception unit 111 receives one or more pieces of sensor data from each of a plurality of monitoring targets (Step S1). The state analysis unit 112 analyzes the state of each of the plurality of monitoring targets based on the received sensor data (Step S2) and determines whether or not a predetermined event has occurred in each monitoring target (Step S3).

When it is determined in Step S3 that a predetermined event has occurred, the surveillant allocation unit 114 determines one of the plurality of surveillants who is responsible for work of monitoring the monitoring target where it has been determined that a predetermined event has occurred based on the predetermined event that has occurred and the load index of each surveillant (Step S4). The monitoring screen display unit may display a detailed monitoring screen (the second monitoring screen) of the monitoring target where it has been determined that a predetermined event has occurred on one of the plurality of display devices that is used by the surveillant determined in Step S4.

As described above, according to this example embodiment, when a surveillant who is responsible for the detailed monitoring work of monitoring a specific monitoring target is determined from among the plurality of surveillants, the monitoring work can be appropriately allocated to the plurality of surveillants.

For example, there may be a case where detailed monitoring work when one event has occurred does not require much labor, whereas detailed monitoring work when another event has occurred may require a lot more time to handle and thus the load of the monitoring work is high. In this example embodiment, when a predetermined event has occurred in a monitoring target, a person who is responsible for the detailed monitoring work is determined using the load index of the monitoring work for which each surveillant has been responsible in the past. Therefore, according to this example embodiment, in the determination of a surveillant who is responsible for detailed monitoring work of a specific monitoring target from among the plurality of surveillants, it is possible to appropriately distribute loads of monitoring work among a plurality of surveillants.

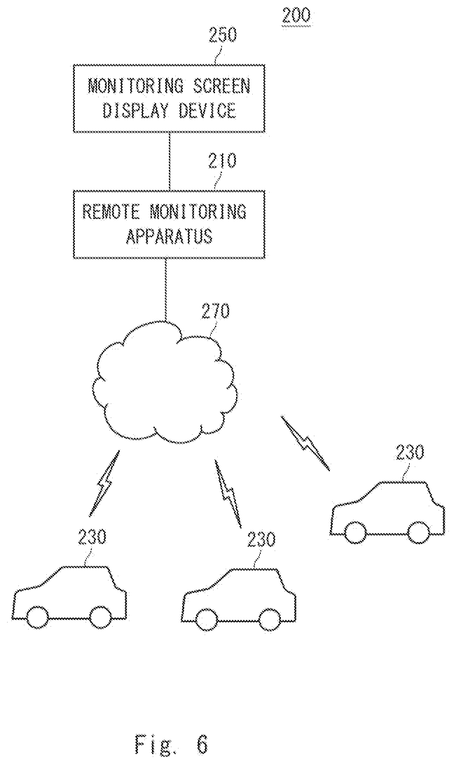

A second example embodiment according to the present disclosure will be described. FIG. 6 shows a monitoring system (remote monitoring system) according to the second example embodiment of the present disclosure. In this example embodiment, a remote monitoring system 200 includes a remote monitoring apparatus 210, a plurality of mobile bodies 230, and a monitoring screen display device 250. In this example embodiment, the monitoring system 100 described in the first example embodiment is applied to remote monitoring of the plurality of mobile bodies 230.

The remote monitoring apparatus 210 is an apparatus for remotely monitoring the plurality of mobile bodies 230. The remote monitoring apparatus 210 is connected to the mobile bodies 230 via a network 270. The network 270 includes, for example, a wireless communication network that uses a communication line standard such as Long Term Evolution (LTE). The network 270 may include a wireless communication network such as WiFi (registered trademark) or a fifth generation mobile communication system. The remote monitoring apparatus 210 may be able to remotely operate the mobile body 230. The remote monitoring apparatus 210 corresponds to the monitoring apparatus 110 shown in FIG. 1.

The monitoring screen display device 250 is a display device for showing information used to monitor the mobile body 230 for the surveillant (operator). The monitoring screen display device 250 may not necessarily be a device that is independent from the remote monitoring apparatus 210 and may be a part of the remote monitoring apparatus 210. The monitoring screen display device 250 includes, for example, a display device such as a liquid crystal display device. The monitoring screen display device 250 may include a display device individually used by each surveillant. Each surveillant may individually use two or more display devices. The monitoring screen display device 250 may include a display device that is commonly used by a plurality of surveillants.

Each mobile body 230 is remotely monitored by the remote monitoring apparatus 210. The mobile body 230 is formed, for example, as a land vehicle such as an automobile, a bus, a taxi, or a truck. The mobile body 230 may be an object such as an underwater drone moving in or on water, or an object such as a flying drone moving in the air. The mobile body 230 may be configured to be able to perform automatic driving (autonomous driving) based on information on sensors mounted on the mobile body. The mobile body 230 may be configured, for example, in such a way that autonomous driving and manual driving by a driver in the vehicle can be switched. The mode of the mobile body 230 may be switched from manual driving to autonomous driving or from autonomous driving to manual driving in accordance with, for example, an instruction transmitted from the remote monitoring apparatus 210. The mobile body 230 may be a railroad, a ship, or an aircraft, or may be a mobile robot such as an Automated Guided Vehicle (AGV).

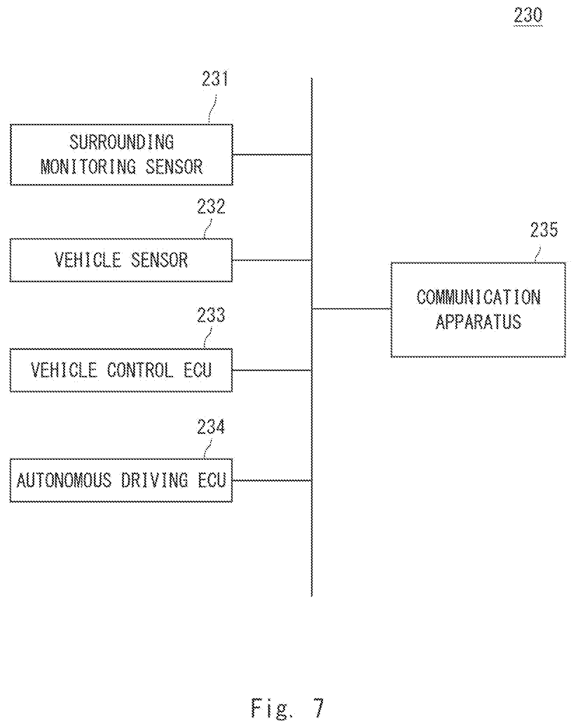

FIG. 7 shows a configuration example of the mobile body 230. The mobile body 230 includes a surrounding monitoring sensor 231, a vehicle sensor 232, a vehicle control Electric Control Unit (ECU) 233, an autonomous driving ECU 234, and a communication apparatus 235. In the mobile body 230, these components are configured in such a way that they can communicate with one another via an on-board Local Area Network (LAN), a Controller Area Network (CAN) or the like.

The surrounding monitoring sensor 231 is a sensor that monitors a situation near the mobile body 230. In the following descriptions, as an example, it is assumed that the surrounding monitoring sensor 231 is a camera. However, it is merely an example. The surrounding monitoring sensor 231 includes, for example, a camera, a Depth camera, a radar, a Light Detection and Ranging (LiDAR) and the like. The surrounding monitoring sensor 231 may include a plurality of cameras that capture images of, for example, the front, the rear, the right side, and the left side of the vehicle. The surrounding monitoring sensor 231 may include a camera that captures an image inside the mobile body 230.

The vehicle sensor 232 is a sensor for detecting various states of the mobile body 230. The vehicle sensor 232 includes, for example, sensors such as a vehicle speed sensor that detects the vehicle speed, a steering sensor that detects a steering angle, an accelerator opening sensor that detects the opening of an accelerator pedal, and a brake depression force sensor that detects the amount of depression of a brake pedal. The vehicle sensor 232 may include a positional information sensor that acquires positional information of the mobile body 230. At least one of the surrounding monitoring sensor 231 or the vehicle sensor 232 corresponds to the sensor 130 shown in FIG. 1.

The vehicle control ECU 233 is an electronic control device configured to perform traveling control or the like of the mobile body 230. In general, the electronic control device includes a processor, a memory, an Input/Output (I/O), and a bus connecting these devices. The vehicle control ECU 233 performs various kinds of control such as control of a fuel injection amount, control of a timing of engine ignition, and control of a power steering assist amount based on the sensor information output from the vehicle sensor 232.

The autonomous driving ECU 234 is an electronic control device that controls autonomous driving of the mobile body 230. The autonomous driving ECU 234 acquires sensor information from the surrounding monitoring sensor 231 and the vehicle sensor 232 and controls autonomous driving of the mobile body 230 based on the acquired sensor information.

The communication apparatus 235 is configured as an apparatus that performs wireless communication between the mobile body 230 and the network 270 (see FIG. 6). The communication apparatus 235 includes, as a hardware configuration, an antenna for wireless communication, a transmitter, and a receiver. Further, the communication apparatus 235 includes a processor, a memory, an I/O, and a bus connecting these devices. The functions of the respective parts in the communication apparatus 235 are implemented, for example, by executing the control program stored in the memory by a processor.

The communication apparatus 235 acquires a camera image acquired by the surrounding monitoring sensor 231, and transmits the acquired camera image (video image data) to the remote monitoring apparatus 210 via the network 270. The communication apparatus 235 further acquires sensor information such as vehicle speed information from the vehicle sensor 232 and transmits the acquired sensor information to the remote monitoring apparatus 210 via the network 270.

The communication apparatus 235 can receive information regarding control of the mobile body 230 from the remote monitoring apparatus 210 via the network 270. The communication apparatus 235 can receive, for example, control information indicating control contents (e.g., a control command) on autonomous driving performed by the mobile body 230 from the remote monitoring apparatus 210. The control contents include, for example, “temporary stop”, “overtake”, “slow down”, and “depart”. The communication apparatus 235 may receive information such as parameters set in the autonomous driving ECU 234 from the remote monitoring apparatus 210. The communication apparatus 235 transmits the received information to the autonomous driving ECU 234 via an on-board LAN or the like. The autonomous driving ECU 234 controls traveling of the mobile body 230 according to the received control contents. Further, the autonomous driving ECU 234 performs autonomous driving of the mobile body 230 using the received parameters etc.

The communication apparatus 235 may receive remote control information, which is information for remotely controlling the mobile body 230, from the remote monitoring apparatus 210. The remote control information includes, for example, information indicating the accelerator opening, the amount of operation of the steering wheel, the amount of depression of the brake pedal, and the like. When the communication apparatus 235 has received the remote control information, the communication apparatus 235 transmits the received remote control information to the vehicle control ECU 233 via the onboard LAN or the like. The vehicle control ECU 233 controls the mobile body 230 based on the received remote control information.

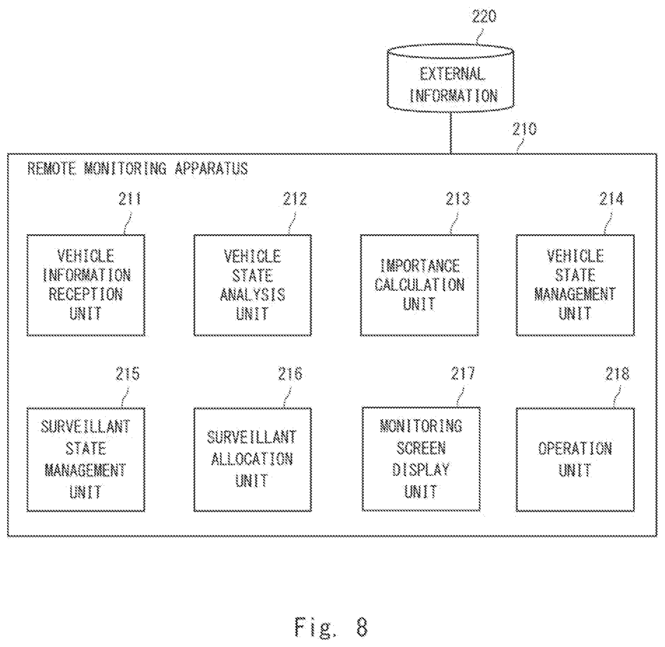

FIG. 8 shows a configuration example of the remote monitoring apparatus 210. The remote monitoring apparatus 210 includes a vehicle information reception unit 211, a vehicle state analysis unit 212, an importance calculation unit 213, a vehicle state management unit 214, a surveillant state management unit 215, a surveillant allocation unit 216, a monitoring screen display unit 217, and an operation unit 218. The vehicle information reception unit 211 receives information transmitted from the communication apparatus 235 (see FIG. 7) of each mobile body 230. The information received by the vehicle information reception unit 211 may include video images captured by a plurality of cameras mounted on the mobile body 230. The vehicle information reception unit 211 receives, for example, video images of the front, the rear, the right side, and the left side of the mobile body 230. The vehicle information reception unit 211 may receive, from the mobile body 230, sensor information acquired by the vehicle sensor 232. The vehicle information reception unit 211 corresponds to the information reception unit 111 shown in FIG. 2.

The vehicle state analysis unit 212 analyzes the state of the mobile body 230 using the information received by the vehicle information reception unit 211. For example, the vehicle state analysis unit 212 analyzes the video image received by the vehicle information reception unit 211 and analyzes the state of the mobile body 230 based on the result of analyzing the video image. The vehicle state analysis unit 212 determines whether or not a predetermined event has occurred in each of the mobile bodies 230 by analyzing the state of each of the plurality of mobile bodies 230.

In this example embodiment, upon detecting a predetermined event, the vehicle state analysis unit 212 issues an alert. The alert issued by the vehicle state analysis unit 212 may include, for example, “approaching a car parked on road”, “entering an intersection”, “approaching a pedestrian crossing”, “entering a dangerous area”, and “approaching a station”. The vehicle state analysis unit 212 recognizes a vehicle stopping in the front from a change in a distance to an object on a travel lane by using, for example, an analysis engine such as object detection, lane detection, and distance estimation. For example, when the vehicle state analysis unit 212 has recognized a vehicle stopping on the travel lane, the vehicle state analysis unit 212 issues an alert of “approaching a car parked on road”. The vehicle state analysis unit 212 recognizes, for example, that the mobile body turns to the right or to the left from route information of the mobile body stored as external information 220, and at least one of information indicated by a direction indicator or the like acquired from the mobile body 230, the current location, or the specified position or a road sign. When the vehicle state analysis unit 212 has recognized that the mobile body turns to the right or to the left, the vehicle state analysis unit 212 issues an alert of “entering an intersection”.

The vehicle state analysis unit 212 recognizes, for example, that the mobile body is approaching a pedestrian crossing from map information stored as the external information 220, the current location of the mobile body, and the specified position or the road sign. When the vehicle state analysis unit 212 has recognized that the mobile body is approaching a pedestrian crossing, the vehicle state analysis unit 212 issues an alert of “approaching a pedestrian crossing”. The vehicle state analysis unit 212 may issue an alert of “approaching a pedestrian crossing” when it has recognized that the mobile body is approaching a pedestrian crossing and there is a person near the pedestrian crossing.

The vehicle state analysis unit 212 determines, for example, whether or not the mobile body has entered an area set in advance where many accidents tend to occur from map information stored as the external information 220 and the current location of the mobile body. When the mobile body has entered the area where many accidents tend to occur, the vehicle state analysis unit 212 issues an alert of “entering a dangerous area”. The vehicle state analysis unit 212 determines whether or not the mobile body is approaching a station from the route information of the mobile body stored as the external information 220 and the current location of the mobile body. When the mobile body is approaching the station, the vehicle state analysis unit 212 issues an alert of “approaching a station”. The vehicle state analysis unit 212 may refer to operation plan information of the mobile body stored as the external information 220 and may issue an alert of “approaching a station” when the current time is close to the time when the mobile body arrives at the station or the time when it departs from the station.

The vehicle state analysis unit 212 stores, for each of the plurality of mobile bodies, the state of the vehicle that has been analyzed in the vehicle state management unit 214. The vehicle state management unit 214 stores, for example, for the issued alert, the time when the alert has been issued, the type of the issued alert, and the importance (priority level) of the alert itself. For example, the importance of alerts related to a high potential for loss of life is set to high. For example, the importance of the alerts of “entering an intersection”, “approaching a pedestrian crossing”, and “entering a dangerous area” is set to high. The vehicle state management unit 214 further stores the current location of the mobile body, the number of passengers in the vehicle, the estimated arrival time and the target arrival time at the next destination (station), the vehicle speed, the person who is responsible for the monitoring, and the importance of monitoring.

When the vehicle state analysis unit 212 has issued an alert, that is, when a predetermined event has occurred in the mobile body 230, the importance calculation unit 213 calculates the importance of monitoring this mobile body 230. The importance calculation unit 213 may calculate the importance of monitoring depending on, for example, the importance of the issued alert itself, a time elapsed after the occurrence of the alert, the vehicle speed of the mobile body, the road status (an arterial road, a residential area, etc.), and a time by which the problem should be handled. When, for example, the mobile body is a vehicle such as a bus, the importance calculation unit 213 may calculate the importance according to the number of passengers in the vehicle and a difference value from the on-time operation (delay time). The difference value from the on-time operation is expressed, for example, by the difference between the estimated arrival time at the next destination and the on-time arrival time at this destination.

Specifically, the importance calculation unit 213 may calculate the importance using the following expression by setting, for example, a as a predetermined coefficient larger than one.

Importance=α×(the importance of the alert itself)+(the number of passengers in the vehicle)×(the difference value from the on-time operation) In this case, it is possible to change the importance of monitoring depending on the difference value from the on-time operation and the number of passengers in the vehicle while focusing on the priority level of the alert itself.

The importance calculation unit 213 stores the calculated importance of monitoring in the vehicle state management unit 214. The vehicle state analysis unit 212 and the importance calculation unit 213 correspond to the state analysis unit 112 shown in FIG. 2.

The surveillant state management unit 215 stores information on a plurality of surveillants. For example, the surveillant state management unit 215 stores, for each of the plurality of surveillants, the total monitoring time, an identifier (ID) of the display device used for the monitoring, the presence flag, the vehicle that he/she monitors, and the load index of the monitoring. The surveillant state management unit 215 may further store information indicating which detailed monitoring work related to which alert each surveillant can be responsible for. For example, the surveillant state management unit 215 stores, regarding one surveillant, information indicating that this surveillant can be responsible for detailed monitoring work when the alerts “entering an intersection” and “approaching a pedestrian crossing” are issued. The surveillant state management unit 215 corresponds to the surveillant state management unit 113 shown in FIG. 2.

When an alert has been issued in the vehicle state analysis unit 212, the surveillant allocation unit 216 determines the surveillant who is responsible for the detailed monitoring work of monitoring the mobile body where an alert has been issued. At this time, the surveillant allocation unit 216 determines one of the plurality of surveillants who is responsible for the detailed monitoring work based on the issued alert and the load index of each surveillant stored in the surveillant state management unit 215. When the alert that the surveillant can handle is determined for each surveillant, the surveillant allocation unit 216 determines, from surveillants who are responsible for detailed monitoring work in response to the occurred alert, the surveillant who is responsible for the detailed monitoring work. The surveillant allocation unit 216 corresponds to the surveillant allocation unit 114 shown in FIG. 2.

The surveillant allocation unit 216 notifies the monitoring screen display unit 217 of the information on the surveillant determined to be responsible for the monitoring work. The surveillant allocation unit 216 notifies the monitoring screen display unit 217 of, for example, information such as the name of the surveillant, the identification information (ID), the seat number, the identification number of the display device used by this surveillant, and the IP address as the information on the determined surveillant.

The monitoring screen display unit 217 controls the screen display in the monitoring screen display device 250. When the vehicle state analysis unit 212 has not issued an alert, the monitoring screen display unit 217 causes the monitoring screen display device 250 to display the overall monitoring screen (the first monitoring screen) for monitoring the plurality of mobile bodies. When the surveillant allocation unit 216 has determined the surveillant who is responsible for the detailed monitoring work of monitoring the mobile body where an alert has been issued, the monitoring screen display unit 217 causes the display device used by this surveillant to display the detailed monitoring screen (the second monitoring screen) of the mobile body 230 where the alert has occurred.

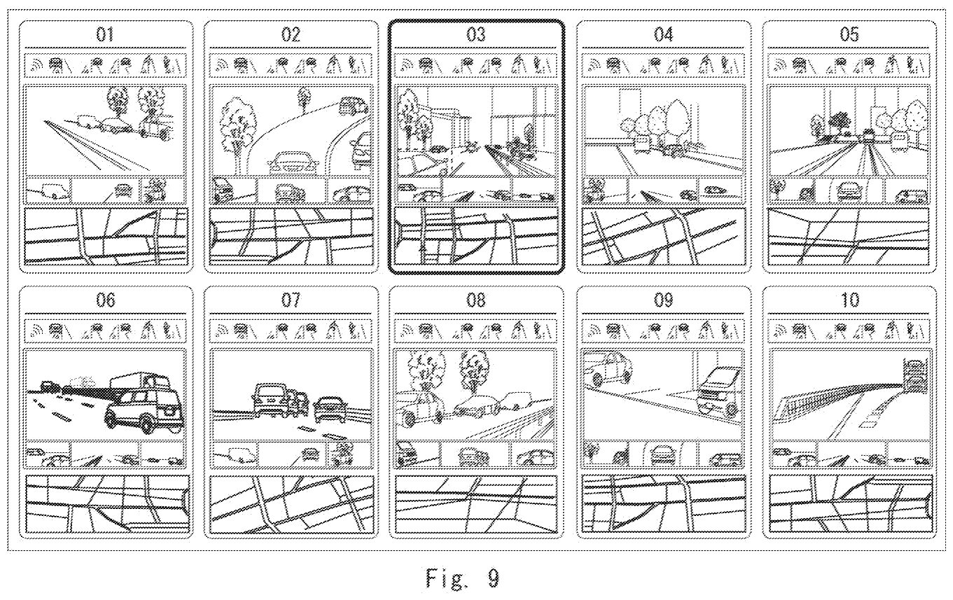

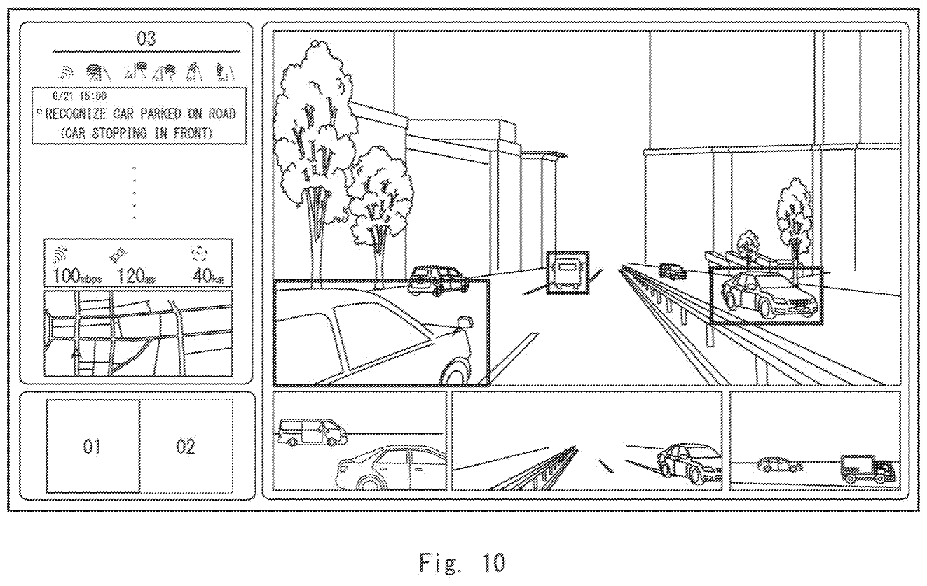

FIG. 9 shows one example of the overall monitoring screen. In the example shown in FIG. 9, the overall monitoring screen includes an area where information on a total of 10 mobile bodies 230 is displayed. The area of each mobile body 230 includes a video image display area, an alert occurrence status display area, and a map information display area. The video image display area is an area that displays the video image received from the mobile body. The alert occurrence status display area is an area for notifying an alert issued in the mobile body. The map information display area is an area which displays a place where the mobile body is traveling. On the overall monitoring screen, a frame border of an area which displays information on the mobile body where an alert is occurring may be displayed by a predetermined color such as, for example, red, or may be highlighted. In the example shown in FIG. 9, an alert occurs for the mobile body whose number is “03” and the area which displays information on this mobile body is surrounded by a thick border.

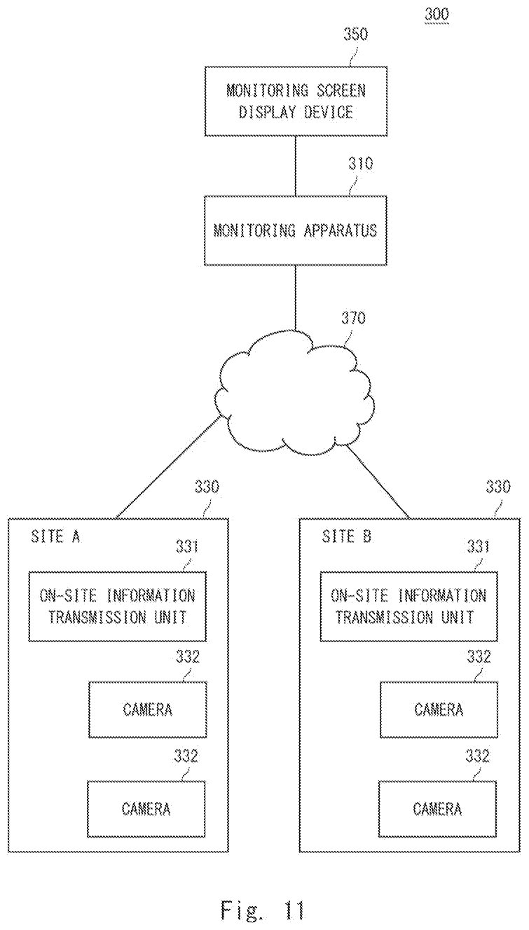

FIG. 10 shows one example of the detailed monitoring screen. The detailed monitoring screen displays, for example, information on one mobile body 230 monitored by a surveillant. The detailed monitoring screen includes an area which displays video images of the front, the rear, the right side, and the left side of the mobile body 230. On the detailed monitoring screen, the information on the mobile body where the alert has occurred is enlarged compared to the information on the mobile body on the overall monitoring screen shown in FIG. 9. The surveillant who has been determined to be responsible for monitoring can perform detailed monitoring work of monitoring the mobile body where the alert has been issued by checking the detailed monitoring screen. In the video image display area, for example, target objects such as other vehicles or pedestrians that have caused the alert may be surrounded by figures such as rectangles. In this case, the surveillant is able to know the positions and the like of the target objects which have caused the alert on the screen.

While the example in which information on one mobile body monitored by the surveillant is displayed on the detailed monitoring screen has been shown in the above description, this example embodiment is not limited to this example. When information on a plurality of mobile bodies 230 is displayed on the detailed monitoring screen, an area which displays information on the mobile body for which the surveillant is responsible may be highlighted. For example, in the detailed monitoring screen which displays information on the plurality of mobile bodies, information on the mobile body for which the surveillant is responsible may be displayed larger than information on other mobile bodies. In other words, the size of the information on the mobile body for which the surveillant is responsible may be enlarged and the size of the information on other mobile bodies may be reduced.

Referring once again to FIG. 8, the operation unit 218 receives input of control information on the mobile body 230. The operation unit 218 includes, for example, an input device such as a touch panel or a mouse. The surveillant who is responsible for the detailed monitoring work of monitoring the mobile body where the alert has occurred determines a situation near the mobile body 230 by checking the video images displayed on the detailed monitoring screen (see FIG. 10). The surveillant inputs the control information on the mobile body 230 into the operation unit 218 as a response to the alert. The response to the alert may be, for example, “no action needed”, “stop”, “departure instruction”, “automatic overtaking instruction”, and “switching to remote driving”. The operation unit 218 may receive control information on a desired mobile body 230 from the surveillant who monitors a plurality of mobile bodies 230 using the overall monitoring screen.

The operation unit 218 transmits a control signal indicating control information input to the mobile body 230 by the surveillant via the network 270 (see FIG. 6). The communication apparatus 235 (see FIG. 7) of the mobile body 230 receives a control signal from the remote monitoring apparatus 210. In the mobile body 230, the automatic control ECU 234 controls the mobile body 230 in accordance with the control contents indicated by the received control signal. The operation unit 218 may transmit information for remotely controlling the mobile body 230 to the mobile body 230. The operation unit 218 includes, for example, equipment for remotely operating a vehicle such as a steering wheel, an accelerator pedal, and a brake pedal. The surveillant (remote driver) is able to control the steering wheel and the like while checking the video images displayed on the detailed monitoring screen. The operation unit 218 transmits information indicating, for example, the operation amount or the like of the steering wheel to the mobile body 230.

In this example embodiment, when an alert is not issued in the vehicle state analysis unit 212, the plurality of mobile bodies 230 are monitored by a plurality of surveillants. Some of the plurality of surveillants may be apparatuses that use Artificial Intelligence (AI). When the number of surveillants is smaller than the number of mobile bodies 230 to be monitored, the mobile body 230 can be efficiently monitored. When an alert has been issued in the vehicle state analysis unit 212, the surveillant allocation unit 216 determines, from among the plurality of surveillants, a surveillant who performs detailed monitoring work of monitoring the mobile body 230 where the alert has been issued. At this time, the surveillant allocation unit 216 determines the surveillant who performs detailed monitoring work using the load index of the past monitoring work of each surveillant. The surveillant who has been determined to be responsible for monitoring performs detailed monitoring work of monitoring the mobile body 230 where the alert has been issued. In this example embodiment, the person who is responsible for the detailed monitoring work is determined using the load index of the monitoring work for which the surveillant has been responsible, whereby it is possible to equalize the load of the monitoring work among a plurality of surveillants. Accordingly, according to this example embodiment, it is possible to prevent monitoring work that requires heavy loads from being concentrated on certain surveillants.

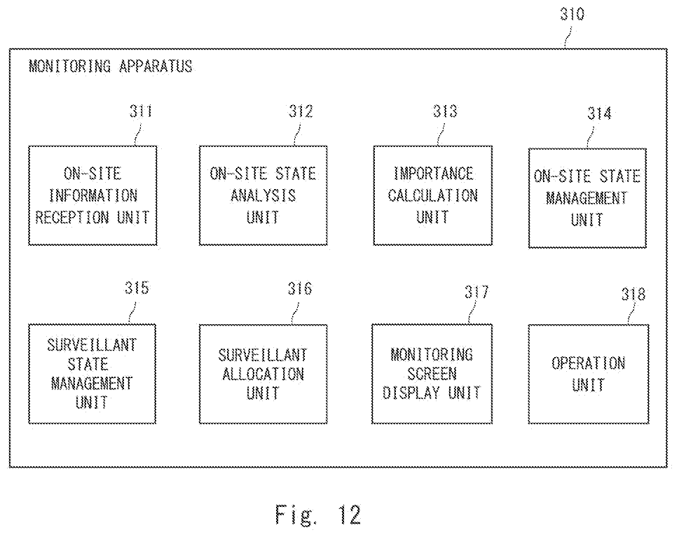

A third example embodiment according to the present disclosure will be described. FIG. 11 shows a monitoring system according to the third example embodiment of the present disclosure. In this example embodiment, a monitoring system 400 includes a monitoring apparatus 310, a plurality of sites 330, and a monitoring screen display device 350. In this example embodiment, the monitoring system 100 described in the first example embodiment is applied to monitor the plurality of sites 330.

The monitoring apparatus 310 is an apparatus for monitoring the plurality of sites 330. In FIG. 11, the monitoring apparatus 310 is used to remotely monitor a site A330 and a site B330. The site A and the site B are not necessarily sites that are different from each other. For example, the site A and the site B may acquire data obtained by capturing images of different areas in one site by cameras and sensor information therein or data obtained by capturing images of one site by cameras at different places and sensor information therein. The monitoring apparatus 310 is connected to the plurality of sites 330 via a network 370. The network 370 includes, for example, a wireless communication network, a wired communication network, or a combination thereof. The monitoring apparatus 310 corresponds to the monitoring apparatus 110 shown in FIG. 1. The monitoring screen display device 350 is a display device for displaying information used to monitor the site 330 for the surveillant (operator). The monitoring screen display device 350 corresponds to the monitoring screen display device 250 shown in FIG. 6.

Each site 330 is monitored by the monitoring apparatus 310. Each site 330 may be, for example, a site such as a construction site where a working vehicle such as a heavy machine is operating. Each site 330 includes an on-site information transmission unit 331 and one or more cameras 332. The camera 322 may be a fixed point camera or may be a camera mounted on a working vehicle. The on-site information transmission unit 331 transmits a video image captured by each camera 332 to the monitoring apparatus 310 via the network 370. The on-site information transmission unit 331 may transmit sensor data of the working vehicle to the monitoring apparatus 310. The sensor data of the working vehicle includes, for example, information such as the angle of a bucket and the angle of an arm. The camera 332 corresponds to the sensor 130 shown in FIG. 1.

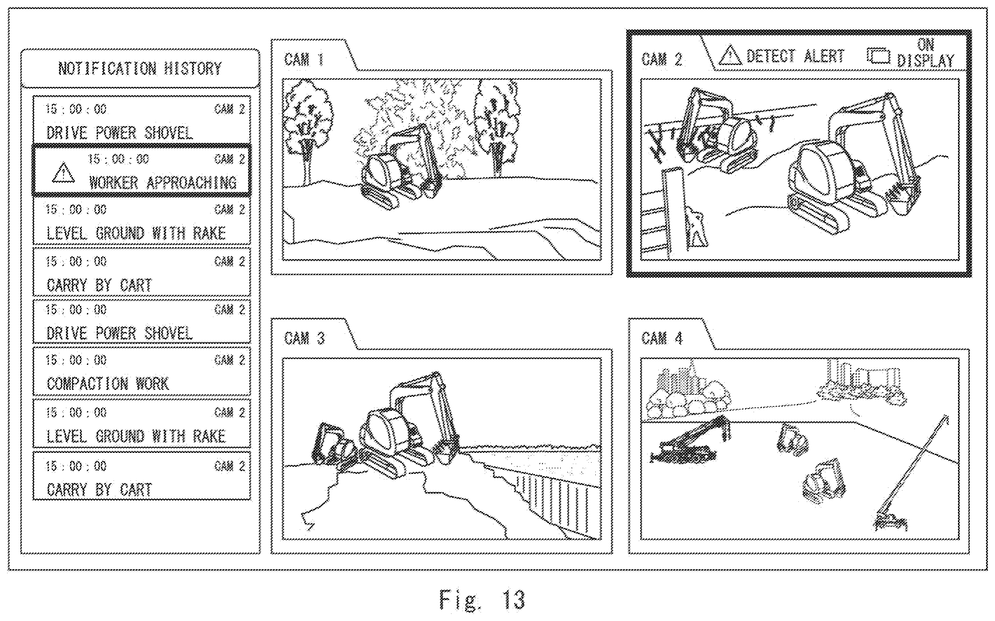

FIG. 12 shows a configuration example of the monitoring apparatus 310. The monitoring apparatus 310 includes an on-site information reception unit 311, an on-site state analysis unit 312, an importance calculation unit 313, an on-site state management unit 314, a surveillant state management unit 315, a surveillant allocation unit 316, a monitoring screen display unit 317, and an operation unit 318. The on-site information reception unit 311 receives information transmitted from the on-site information transmission unit 331 in each site 330 (see FIG. 11). The on-site information reception unit 311 receives the video image captured by the camera 332 from each site 330. The on-site information reception unit 311 corresponds to the information reception unit 111 shown in FIG. 2.

The on-site state analysis unit 312 analyzes the state of the site 330 using the information received by the on-site information reception unit 311. For example, the on-site state analysis unit 312 analyzes the video image received by the on-site information reception unit 311 and analyzes the state of the site 330 based on the results of analyzing the video image. The on-site state analysis unit 312 determines whether or not a predetermined event has occurred in the image-capture range of the camera 332 in each site 330 by analyzing the state of each of the plurality of video images in the plurality of sites 330.

In this example embodiment, upon detecting a predetermined event, the on-site state analysis unit 312 issues an alert. The alert issued by the on-site state analysis unit 312 may include, for example, “unsafe behavior” and “work mistake”. The on-site state analysis unit 312 performs, for example, detection of a person, detection of a human skeleton, and detection of a related equipment object on the video image of the camera 332. For example, the on-site state analysis unit 312 detects, from the video image of the camera 332, a working vehicle such as a power shovel and a worker. When the distance between the working vehicle and the worker is within a predetermined distance, the on-site state analysis unit 312 issues an alert of “unsafe behavior”.

The on-site state analysis unit 312 may identify, for example, scaffolds for working at height from the video image of the camera 332, and then determine whether or not the worker working on the scaffolds for working at height is wearing a safety hook. When the on-site state analysis unit 312 has determined that the worker working on the scaffolds for working at height is not wearing a safety hook, the on-site state analysis unit 312 issues an alert of “unsafe behavior”.

The on-site state analysis unit 312 analyzes, for example, the progress status of the work from the video image of the camera 332. When the work is not executed according to a predetermined work procedure, the on-site state analysis unit 312 issues an alert of “work mistake”. As one example, the on-site state analysis unit 312 analyzes the status of compaction work in a compaction machine. When the number of times of rolling compaction is smaller than a predetermined number of times, the on-site state analysis unit 312 issues an alert of “work mistake”.

The on-site state analysis unit 312 stores, for each of the plurality of sites, the state of the site that has been analyzed in the on-site state management unit 314. For example, the on-site state management unit 314 stores, regarding the issued alert, the time when the alert has been issued, the type of the issued alert, and the importance of the alert itself. For example, the importance of alerts issued in a case where there is a high probability of causing an accident is set to high. For example, the importance of the alert itself of “unsafe behavior” is set to high. The on-site state management unit 314 may store the kinds of objects included in the video image of the camera 332, and the number of objects.

The importance calculation unit 313 calculates, when it is determined that a predetermined event has occurred in the image-capture range of each camera 332, the importance of monitoring the predetermined event that has occurred in the site. The importance calculation unit 313 may calculate the importance of monitoring in accordance with, for example, the importance of the issued alert itself, the distance between a related equipment and a person, and whether or not the problem has been handled. When there are a plurality of kinds of objects in the image-capture range of the camera 332, the importance calculation unit 313 may calculate the importance of monitoring in accordance with the number of objects for each type.

Specifically, the importance calculation unit 313 may calculate the importance using the following expression, assuming, for example, that a is a predetermined coefficient larger than one and Bi is a predetermined coefficient for the object i.

Importance=α×(importance of alert itself)+Σ[βᵢ×(number of objects i)]

In this case, it is possible to change the importance of monitoring in accordance with the number of objects for each type while focusing on the priority level of the alert itself. The importance calculation unit 313 stores the calculated importance of monitoring in the on-site state management unit 314. The on-site state analysis unit 312 and the importance calculation unit 313 correspond to the state analysis unit 112 shown in FIG. 2.

The surveillant state management unit 315 stores information on a plurality of surveillants. For example, the surveillant state management unit 315 stores, for each of a plurality of surveillants, the total monitoring time, the identifier (ID) of the display device used for monitoring, the presence flag, the site (camera) that he/she monitors, and the load index of monitoring. The surveillant state management unit 315 may further store information indicating which detailed monitoring work related to which alert each surveillant can be responsible for. The surveillant state management unit 315 corresponds to the surveillant state management unit 113 shown in FIG. 2.

The surveillant allocation unit 316 determines, when the alert has been issued in the on-site state analysis unit 312, a surveillant who is responsible for detailed monitoring work of monitoring the camera image where the alert has been issued. At this time, the surveillant allocation unit 316 determines one of the plurality of surveillants who is responsible for the detailed monitoring work based on the issued alert and the load index of each surveillant stored in the surveillant state management unit 315. When the alert that the surveillant can handle is determined for each surveillant, the surveillant allocation unit 316 determines, from among the surveillants who can be responsible for detailed monitoring work in response to the occurred alert, the surveillant who is responsible for the detailed monitoring work. The surveillant allocation unit 316 corresponds to the surveillant allocation unit 114 shown in FIG. 2.

The monitoring screen display unit 317 controls the screen display in the monitoring screen display device 350. When the on-site state analysis unit 312 has not issued an alert, the monitoring screen display unit 317 causes the monitoring screen display device 350 to display an overall monitoring screen for monitoring a plurality of sites. When the surveillant allocation unit 316 has determined the surveillant who is responsible for the detailed monitoring work of monitoring the site where the alert has been issued, the monitoring screen display unit 317 causes the display device used by this surveillant to display the detailed monitoring screen of the site where the alert has occurred.

FIG. 13 shows one example of the overall monitoring screen. In the example shown in FIG. 13, the overall monitoring screen includes an area that displays video images of a total of four sites (cameras). On the overall monitoring screen, a frame border of an area which displays a video image of the camera where an alert is occurring may be displayed by a predetermined color, such as red, or may be highlighted. In the example shown in FIG. 13, the alert occurs in the camera of CAM 2, and the area that displays the video image of this camera is surrounded by a thick border. On the overall monitoring screen, a notification history of alerts may be displayed, or information such as operations, processes or the like of a target whose image has been captured as each video image may be displayed.

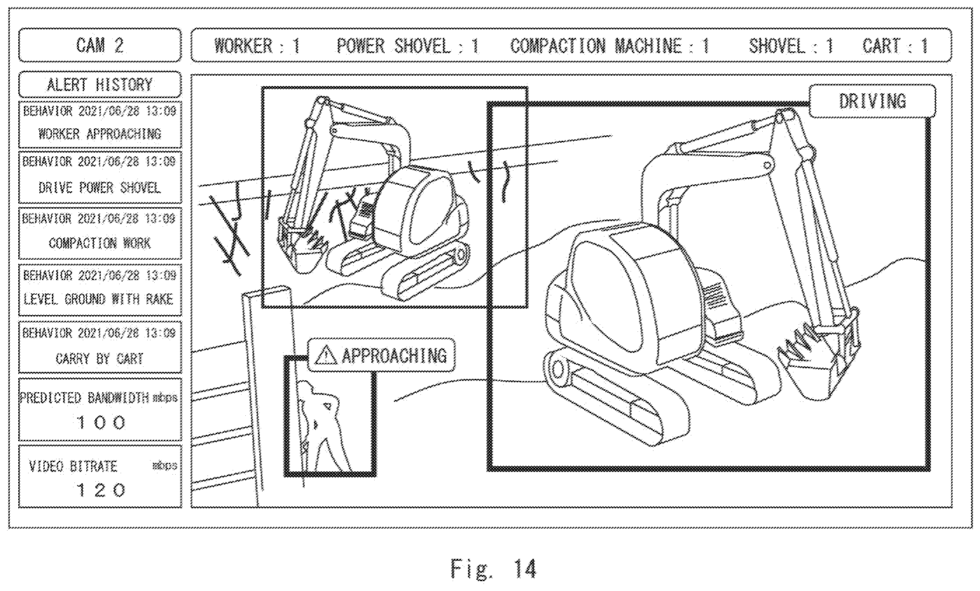

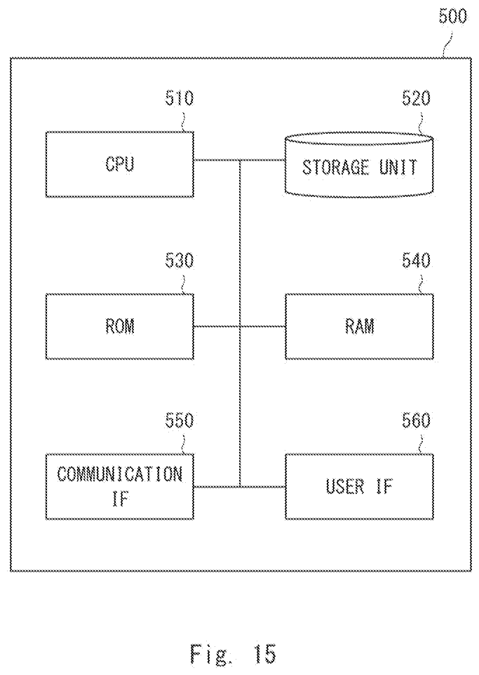

FIG. 14 shows one example of the detailed monitoring screen. On the detailed monitoring screen, for example, a video image of one camera monitored by a surveillant is displayed. On the detailed monitoring screen, a video image of the camera where an alert has occurred is enlarged as compared to the video image of the camera on the overall monitoring screen shown in FIG. 13. The surveillant who has been determined to be responsible for monitoring is able to execute the detailed monitoring work of monitoring the site where the alert has been issued by checking the detailed monitoring screen. In the video image display area, objects such as a heavy machine and a person which have caused the alert may be surrounded by figures such as rectangles. In this case, the surveillant can recognize, on the screen, the positions and the like of the objects that have caused the alert.

Referring once again to FIG. 12, the operation unit 318 receives input of control information to the site 330. The surveillant who is responsible for the detailed monitoring work of monitoring the site where the alert has occurred determines the status of this site by checking the video images displayed on the detailed monitoring screen (see FIG. 14). The surveillant inputs control information for sending a warning to the site into the operation unit 318 as a response to the alert. When it is possible to remotely control the working vehicle, the surveillant can input the control information on the working vehicle as a response to the alert.

The operation unit 318 transmits a control signal indicating the control information that the surveillant has input to the site 330 via the network 370 (see FIG. 6). In the site 330, for example, a broadcasting unit such as a speaker or a lump that is not shown sends an alert to a person who works at a site. When the control signal includes control information on the working vehicle, the working vehicle operates according to the control information.

In this example embodiment, when no alert has been issued in the on-site state analysis unit 312, a plurality of sites 330 are monitored by a plurality of surveillants. When the number of surveillants is smaller than the number of sites 330 to be monitored, the sites 330 can be efficiently monitored. When an alert has been issued in the on-site state analysis unit 312, the surveillant allocation unit 316 determines a surveillant who performs detailed monitoring work of monitoring the site 330 where the alert has been issued from among the plurality of surveillants. At this time, the surveillant allocation unit 316 determines the surveillant who performs detailed monitoring work using the load index of the past monitoring work of each surveillant. The surveillant who has been determined to be responsible for monitoring performs detailed monitoring work of the site 330 where the alert has been issued. In this example embodiment, a person who is responsible for the detailed monitoring work is determined using the load index of the monitoring work for which this surveillant has been responsible in the past, whereby it is possible to equalize the loads of the monitoring work among a plurality of surveillants. Accordingly, in this example embodiment as well, like in the second example embodiment, it is possible to prevent monitoring work that requires heavy loads from being concentrated on certain surveillants.

In the second and third example embodiments, the example in which a red frame border is used on the overall monitoring screen (see FIGS. 9 and 13) in order to highlight the monitoring target where the alert has occurred has been described. However, the present disclosure is not limited to this example. The displayed color of the frame border is not limited to red, and may be blue or green. The monitoring target where the alert has occurred may be highlighted by blinking the frame border.

Alternatively or additionally, on the overall monitoring screen, the monitoring target where the alert has occurred may be highlighted by making the brightness of the display of the monitoring target where the alert has occurred different from that of the monitoring target where an alert does not occur. For example, on the overall monitoring screen, the display luminance of the monitoring target where an alert does not occur may be reduced and the monitoring target where the alert has occurred may be relatively made brighter.

On the overall monitoring screen, the aspect of highlighting may be changed depending on the importance of monitoring the monitoring target where the alert has occurred. For example, on the overall monitoring screen, regarding a monitoring target having the highest importance of monitoring, the red frame border that surrounds the area which displays information on this monitoring target may be blinked. On the overall monitoring screen, regarding a monitoring target whose importance of monitoring is not very high, the area which displays information on this monitoring target may be surrounded by a frame border whose color is different from red, such as blue. In this case, the surveillant is able to easily recognize, when statuses with different importance of monitoring occur in a plurality of monitoring targets, a monitoring target where the status with high importance of monitoring has occurred.

In the present disclosure, the monitoring apparatus 110 may be configured as a computer apparatus (a server apparatus). FIG. 15 shows a configuration example of a computer apparatus that may be used as the monitoring apparatus 110. A computer apparatus 500 includes a control unit (CPU: Central Processing Unit) 510, a storage unit 520, a Read Only Memory (ROM) 530, a Random Access Memory (RAM) 540, a communication interface (IF) 550, and a user interface 560. The computer apparatus 500 may be used as the remote monitoring apparatus 210 or the monitoring apparatus 310.

The communication interface 550 is an interface for connecting the computer apparatus 500 with a communication network via wired communication means or wireless communication means. The user interface 560 includes, for example, a display unit such as a display. Further, the user interface 560 includes an input unit such as a keyboard, a mouse, and a touch panel.

The storage unit 520 is an auxiliary storage device capable of holding various kinds of data. The storage unit 520 may not necessarily be a part of the computer apparatus 500. The storage unit 520 may be an external storage device or may be a cloud storage connected to the computer apparatus 500 via the network.

The ROM 530 is a non-volatile storage device. The ROM 530 may be, for example, a semiconductor storage device such as a flash memory with a relatively low capacity. The program executed by the CPU 510 may be stored in the storage unit 520 or the ROM 530. The storage unit 520 or the ROM 530 stores, for example, various kinds of programs for implementing the functions of the respective parts in the remote monitoring apparatus 210.

The program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a Compact Disc (CD), a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The RAM 540 is a volatile storage device. The RAM 540 may be various semiconductor memory devices such as a Dynamic Random Access Memory (DRAM) or a Static Random Access Memory (SRAM). The RAM 540 may be used as an internal buffer that temporarily stores data or the like. The CPU 510 loads the program stored in the storage unit 520 or the ROM 530 in the RAM 540 and executes the deployed program. The CPU 510 executes the program, whereby functions of the respective units in the remote monitoring apparatus 210 may be implemented. The CPU 510 may include an internal buffer capable of temporarily storing data and the like.

While the example embodiments of the present disclosure have been described in detail, the present disclosure is not limited to the aforementioned example embodiments and various changes or modifications of the aforementioned example embodiments without departing from the spirit of the present disclosure may also be included in the present disclosure.

For example, the whole or part of the example embodiments disclosed above can be described as, but not limited to, the following supplementary notes.

### [Supplementary Note 1]

A monitoring apparatus comprising:
information reception means for receiving one or more pieces of sensor data from each of a plurality of monitoring targets:
state analysis means for analyzing the state of each of the plurality of monitoring targets based on the sensor data and determining whether or not a predetermined event has occurred in each of the monitoring targets:
surveillant state management means for managing, regarding each of a plurality of surveillants who monitor at least one of the plurality of monitoring targets, a load index indicating labor of monitoring work; and
surveillant allocation means for determining, when it is determined in the state analysis means that the predetermined event has occurred in one or more of the monitoring targets, one of the plurality of surveillants who is responsible for work of monitoring the monitoring target where it has been determined that the predetermined event has occurred based on the predetermined event that has occurred and the load index.

### [Supplementary Note 2]

The monitoring apparatus according to Supplementary Note 1, wherein
the state analysis means further calculates importance of monitoring a predetermined event that has occurred in the monitoring target, and
the surveillant state management means updates, when the surveillant determined in the surveillant allocation means has performed the monitoring work, the load index of this surveillant in accordance with the importance of monitoring.

### [Supplementary Note 3]

The monitoring apparatus according to Supplementary Note 2, wherein the surveillant allocation means determines, when it has been determined that predetermined events have occurred in the plurality of monitoring targets, surveillants who are responsible for the monitoring work in a descending order of the importance of monitoring.

### [Supplementary Note 4]

The monitoring apparatus according to Supplementary Note 2 or 3, wherein
the monitoring target is a mobile body, and
the state analysis means calculates the importance of monitoring in accordance with the number of passengers in the mobile body, the situation of the road on which the mobile body is traveling, or a combination thereof.

### [Supplementary Note 5]

The monitoring apparatus according to any one of Supplementary Notes 1 to 4, wherein
the surveillant state management means further monitors monitoring work for which the plurality of respective surveillants can be responsible, and
the surveillant allocation means specifies one or more of the plurality of surveillants who can be responsible for work of monitoring the monitoring target where it has been determined that the predetermined event has occurred, and determines a surveillant who is responsible for the monitoring work from among the one or more specified surveillants based on the predetermined event that has occurred and the load index.

### [Supplementary Note 6]

The monitoring apparatus according to any one of Supplementary Notes 1 to 5, wherein
the surveillant state management means further manages handling abilities of the plurality of respective surveillants of handling the predetermined event in the monitoring work, and
the surveillant allocation means determines a surveillant who is responsible for the monitoring work further based on the handling abilities.

### [Supplementary Note 7]

The monitoring apparatus according to any one of Supplementary Notes 1 to 6, wherein
monitoring screen display means for displaying, on the display device used by the determined surveillant, one or more pieces of sensor data received from the monitoring target where it has been determined that the predetermined event has occurred,
wherein the monitoring screen display means is able to display, on the display device, a first monitoring screen for monitoring the plurality of monitoring targets and a second monitoring screen for monitoring the monitoring target where it has been determined that the predetermined event has occurred, cause, when it is not determined in the state analysis means that the predetermined event has occurred in one or more of the monitoring targets, the surveillant to monitor the plurality of monitoring targets using the first monitoring screen, and display, when it is determined in the surveillant allocation means that a surveillant who is responsible for work of monitoring the monitoring target where it has been determined that the predetermined event has occurred, the second monitoring screen on a display device used by the determined surveillant to cause the surveillant to monitor the monitoring target where it has been determined that the predetermined event has occurred.

### [Supplementary Note 8]

A monitoring system comprising:
a monitoring apparatus used to monitor a plurality of monitoring targets; and a plurality of sensors configured to acquire sensor data of the plurality of monitoring targets, wherein the monitoring apparatus comprises:
information reception means for receiving sensor data from the plurality of sensors:
state analysis means for analyzing the state of each of the plurality of monitoring targets based on the sensor data and determining whether or not a predetermined event has occurred in each of the monitoring targets:
surveillant state management means for managing, regarding each of a plurality of surveillants who monitor at least one of the plurality of monitoring targets, a load index indicating labor of monitoring work; and
surveillant allocation means for determining, when it is determined in the state analysis means that the predetermined event has occurred in one or more of the monitoring targets, one of the plurality of surveillants who is responsible for work of monitoring the monitoring target where it has been determined that the predetermined event has occurred based on the predetermined event that has occurred and the load index.

### [Supplementary Note 9]

The monitoring system according to Supplementary Note 8, wherein
the state analysis means further calculates importance of monitoring a predetermined event that has occurred in the monitoring target, and
the surveillant state management means updates, when the surveillant determined in the surveillant allocation means has performed the monitoring work, the load index of this surveillant in accordance with the importance of monitoring.

### [Supplementary Note 10]

The monitoring system according to Supplementary Note 9, wherein the surveillant allocation means determines, when it has been determined that predetermined events have occurred in the plurality of monitoring targets, surveillants who are responsible for the monitoring work in a descending order of the importance of monitoring.

### [Supplementary Note 11]

The monitoring system according to Supplementary Note 9 or 10, wherein
the monitoring target is a mobile body, and
the state analysis means calculates the importance of monitoring in accordance with the number of passengers in the mobile body, the situation of the road on which the mobile body is traveling, or a combination thereof.

### [Supplementary Note 12]

The monitoring system according to any one of Supplementary Notes 8 to 11, wherein
the surveillant state management means further monitors monitoring work for which the plurality of respective surveillants can be responsible, and
the surveillant allocation means specifies one or more of the plurality of surveillants who can be responsible for work of monitoring the monitoring target where it has been determined that the predetermined event has occurred, and determines a surveillant who is responsible for the monitoring work from among the one or more specified surveillants based on the predetermined event that has occurred and the load index.

### [Supplementary Note 13]

The monitoring system according to any one of Supplementary Notes 8 to 12, wherein
the surveillant state management means further manages handling abilities of the plurality of respective surveillants of handling the predetermined event in the monitoring work, and
the surveillant allocation means determines a surveillant who is responsible for the monitoring work further based on the handling abilities.

### [Supplementary Note 14]

The monitoring system according to any one of Supplementary Notes 8 to 13, wherein
the monitoring apparatus further includes monitoring screen display means for displaying, on a display device used by the determined surveillant, one or more pieces of sensor data received from the monitoring target where it has been determined that the predetermined event has occurred, and
wherein the monitoring screen display means is able to display, on the display device, a first monitoring screen for monitoring the plurality of monitoring targets and a second monitoring screen for monitoring the monitoring target where it has been determined that the predetermined event has occurred, cause, when it is not determined in the state analysis means that the predetermined event has occurred in one or more of the monitoring targets, the surveillant to monitor the plurality of monitoring targets using the first monitoring screen, and display, when it is determined in the surveillant allocation means that a surveillant who is responsible for work of monitoring the monitoring target where it has been determined that the predetermined event has occurred, the second monitoring screen on a display device used by the determined surveillant to cause the surveillant to monitor the monitoring target where it has been determined that the predetermined event has occurred.

### [Supplementary Note 15]

A monitoring method comprising:
receiving one or more pieces of sensor data from each of a plurality of monitoring targets:
analyzing the state of each of the plurality of monitoring targets based on the sensor data and determining whether or not a predetermined event has occurred in each of the monitoring targets; and
determining, when it is determined that the predetermined event has occurred in one or more of the monitoring targets, a surveillant who is responsible for work of monitoring the monitoring target where it has been determined that the predetermined event has occurred from among the plurality of surveillants who monitor at least one of the plurality of monitoring targets based on the predetermined event that has occurred and a load index indicating labor of monitoring work of a surveillant.

### [Supplementary Note 16]

The monitoring method according to Supplementary Note 15, further comprising:
calculating importance of monitoring of a predetermined event that has occurred in the monitoring target; and
updating, when the determined surveillant has performed the monitoring work, the load index of this surveillant in accordance with the importance of monitoring.

### [Supplementary Note 17]

The monitoring method according to Supplementary Note 16, comprising determining, when it has been determined that predetermined events have occurred in the plurality of monitoring targets, surveillants who are responsible for the monitoring work in a descending order of the importance of monitoring.

### [Supplementary Note 18]

The monitoring method according to Supplementary Note 16 or 17, wherein
the monitoring target is a mobile body, and
in the calculation of the importance of monitoring, the importance of monitoring is calculated in accordance with the number of passengers in the mobile body, the situation of the road on which the mobile body is traveling, or a combination thereof.

### [Supplementary Note 19]

The monitoring method according to any one of Supplementary Notes 15 to 18, wherein determining the surveillant who is responsible for the monitoring work comprises specifying one or more of the plurality of surveillants who can be responsible for work of monitoring the monitoring target where it has been determined that the predetermined event has occurred and determining a surveillant who is responsible for the monitoring work from among the one or more specified surveillants based on the predetermined event that has occurred and the load index.

### [Supplementary Note 20]

The monitoring method according to any one of Supplementary Notes 15 to 19, wherein determining the surveillant who is responsible for the monitoring work comprises determining a surveillant who is responsible for the monitoring work based on a handling ability of the surveillant of handling the predetermined event in the monitoring work.

### [Supplementary Note 21]

The monitoring method according to any one of Supplementary Notes 15 to 20, further comprising:
displaying, on a display device used by the determined surveillant, one or more pieces of sensor data received from the monitoring target where it has been determined that the predetermined event has occurred; and
causing, when it is not determined that the predetermined event has occurred in the monitoring target, the surveillant to monitor the plurality of monitoring targets using a first monitoring screen for monitoring the plurality of monitoring targets, and displaying, when a surveillant who is responsible for work of monitoring the monitoring target where it has been determined that the predetermined event has occurred has been determined, a second monitoring screen for monitoring the monitoring target where it has been determined that the predetermined event has occurred on the display device used by the determined surveillant to cause the surveillant to monitor the monitoring target where it has been determined that the predetermined event has occurred.

### REFERENCE SIGNS LIST

100: MONITORING SYSTEM
110: MONITORING APPARATUS
111: INFORMATION RECEPTION UNIT
112: STATE ANALYSIS UNIT
113: SURVEILLANT STATE MANAGEMENT UNIT
114: SURVEILLANT ALLOCATION UNIT
130: SENSOR
200: REMOTE MONITORING SYSTEM
210: REMOTE MONITORING APPARATUS
211: VEHICLE INFORMATION RECEPTION UNIT
212: VEHICLE STATE ANALYSIS UNIT
213: IMPORTANCE CALCULATION UNIT
214: VEHICLE STATE MANAGEMENT UNIT
215: SURVEILLANT STATE MANAGEMENT UNIT
216: SURVEILLANT ALLOCATION UNIT
217: MONITORING SCREEN DISPLAY UNIT
218: OPERATION UNIT
230: MOBILE BODY
231: SURROUNDING MONITORING SENSOR
232: VEHICLE SENSOR
233: VEHICLE CONTROL ECU
234: AUTONOMOUS DRIVING ECU
235: COMMUNICATION APPARATUS
250: MONITORING SCREEN DISPLAY DEVICE
270: NETWORK
300: MONITORING SYSTEM
310: MONITORING APPARATUS
311: ON-SITE INFORMATION RECEPTION UNIT
312: ON-SITE STATE ANALYSIS UNIT
313: IMPORTANCE CALCULATION UNIT
314: ON-SITE STATE MANAGEMENT UNIT
315: SURVEILLANT STATE MANAGEMENT UNIT
316: SURVEILLANT ALLOCATION UNIT
317: MONITORING SCREEN DISPLAY UNIT
318: OPERATION UNIT
330: SITE
331: ON-SITE INFORMATION TRANSMISSION UNIT
332: CAMERA
350: MONITORING SCREEN DISPLAY DEVICE
370: NETWORK
500: COMPUTER APPARATUS
510: CPU
520: STORAGE UNIT
530: ROM
540: RAM
550: COMMUNICATION INTERFACE
560: USER INTERFACE

What is claimed is:

1. A monitoring apparatus comprising:
at least one memory storing instructions; and
at least one processor configured to execute the instructions to:
receive one or more pieces of sensor data from each of a plurality of monitoring targets;
analyze the state of each of the plurality of monitoring targets based on the sensor data and determine whether or not a predetermined event has occurred in each of the monitoring targets;
manage, regarding each of a plurality of surveillants who monitor at least one of the plurality of monitoring targets, a load index indicating labor of monitoring work; and
determine, when it is determined that the predetermined event has occurred in one or more of the monitoring targets, one of the plurality of surveillants who is responsible for work of monitoring the monitoring target where it has been determined that the predetermined event has occurred based on the predetermined event that has occurred and the load index.

2. The monitoring apparatus according to claim 1, wherein
the at least one processor is configured to execute the instructions to:
calculate importance of monitoring a predetermined event that has occurred in the monitoring target, and
update updates, when the determined surveillant has performed the monitoring work, the load index of this surveillant in accordance with the importance of monitoring.

3. The monitoring apparatus according to claim 2, wherein the at least one processor is configured to execute the instructions to determine, when it has been determined that predetermined events have occurred in the plurality of monitoring targets, surveillants who are responsible for the monitoring work in a descending order of the importance of monitoring.

4. The monitoring apparatus according to claim 2, wherein
the monitoring target is a mobile body, and
the at least one processor is configured to execute the instructions to calculate the importance of monitoring in accordance with a number of passengers in the mobile body, a situation of the road on which the mobile body is traveling, or a combination thereof.

5. The monitoring apparatus according to claim 1, wherein
the at least one processor is configured to execute the instructions to:
manage monitoring work for which the plurality of respective surveillants can be responsible, and
specify one or more of the plurality of surveillants who can be responsible for work of monitoring the monitoring target where it has been determined that the predetermined event has occurred, and determines a surveillant who is responsible for the monitoring work from among the one or more specified surveillants based on the predetermined event that has occurred and the load index.

6. The monitoring apparatus according to claim 1, wherein
the at least one processor is configured to execute the instructions to:
manage handling abilities of the plurality of respective surveillants of handling the predetermined event in the monitoring work, and
determine a surveillant who is responsible for the monitoring work further based on the handling abilities.

7. The monitoring apparatus according to claim 1, wherein:
the at least one processor is further configured to execute the instructions to display, on a display device used by the determined surveillant, one or more pieces of sensor data received from the monitoring target where it has been determined that the predetermined event has occurred, and
the at least one processor is configured to execute the instructions to display, when it is not determined that the predetermined event has occurred in one or more of the monitoring targets, a first monitoring screen for monitoring the plurality of monitoring targets on the display device to cause the surveillant to monitor the plurality of monitoring targets using the first monitoring screen, and display, when a surveillant who is responsible for work of monitoring the monitoring target where it has been determined that the predetermined event has occurred is determined, a second monitoring screen for monitoring the monitoring target where it has been determined that the predetermined event has occurred on a display device used by the determined surveillant to cause the surveillant to monitor the monitoring target where it has been determined that the predetermined event has occurred.

8. A monitoring system comprising:
a monitoring apparatus used to monitor a plurality of monitoring targets, the monitoring apparatus comprising at least one memory storing instructions and at least one processor configured to execute the instructions; and
a plurality of sensors configured to acquire sensor data of the plurality of monitoring targets, wherein the at least one processor is configured to execute the instructions to:
receive sensor data from the plurality of sensors;
analyze the state of each of the plurality of monitoring targets based on the sensor data and determining whether or not a predetermined event has occurred in each of the monitoring targets;
manage, regarding each of a plurality of surveillants who monitor at least one of the plurality of monitoring targets, a load index indicating labor of monitoring work; and
determine, when it is determined that the predetermined event has occurred in one or more of the monitoring targets, one of the plurality of surveillants who is responsible for work of monitoring the monitoring target where it has been determined that the predetermined event has occurred based on the predetermined event that has occurred and the load index.

9. The monitoring system according to claim 8, wherein
the at least one processor is configured to execute the instructions to:
calculate importance of monitoring a predetermined event that has occurred in the monitoring target, and
update, when the determined surveillant determined has performed the monitoring work, the load index of this surveillant in accordance with the importance of monitoring.

10. The monitoring system according to claim 9, wherein the at least one processor is configured to execute the instructions to determine, when it has been determined that predetermined events have occurred in the plurality of monitoring targets, surveillants who are responsible for the monitoring work in a descending order of the importance of monitoring.

11. The monitoring system according to claim 9, wherein
the monitoring target is a mobile body, and
the at least one processor is configured to execute the instructions to calculate the importance of monitoring in accordance with a number of passengers in the mobile body, a situation of the road on which the mobile body is traveling, or a combination thereof.

12. The monitoring system according to claim 8, wherein
the at least one processor is configured to execute the instructions to:
manage monitoring work for which the plurality of respective surveillants can be responsible, and
specify one or more of the plurality of surveillants who can be responsible for work of monitoring the monitoring target where it has been determined that the predetermined event has occurred, and determine a surveillant who is responsible for the monitoring work from among the one or more specified surveillants based on the predetermined event that has occurred and the load index.

13. The monitoring system according to claim 8, wherein
the at least one processor is configured to execute the instructions to:
manage handling abilities of the plurality of respective surveillants of handling the predetermined event in the monitoring work, and
determine a surveillant who is responsible for the monitoring work further based on the handling abilities.

14. The monitoring system according to claim 8, wherein
the at least one processor is further configured to execute the instructions to display, on a display device used by the determined surveillant, one or more pieces of sensor data received from the monitoring target where it has been determined that the predetermined event has occurred, and
the at least one processor is configured to execute the instructions to display, when it is not determined that the predetermined event has occurred in one or more of the monitoring targets, a first monitoring screen for monitoring the plurality of monitoring targets to cause the surveillant to monitor the plurality of monitoring targets using the first monitoring screen, and display, when a surveillant who is responsible for work of monitoring the monitoring target where it has been determined that the predetermined event has occurred is determined, a second monitoring screen for monitoring the monitoring target where it has been determined that the predetermined event has occurred on a display device used by the determined surveillant to cause the surveillant to monitor the monitoring target where it has been determined that the predetermined event has occurred.

15. A monitoring method comprising:
receiving one or more pieces of sensor data from each of a plurality of monitoring targets;
analyzing the state of each of the plurality of monitoring targets based on the sensor data and determining whether or not a predetermined event has occurred in each of the monitoring targets; and
determining, when it is determined that the predetermined event has occurred in one or more of the monitoring targets, a surveillant who is responsible for work of monitoring the monitoring target where it has been determined that the predetermined event has occurred from among the plurality of surveillants who monitor at least one of the plurality of monitoring targets based on the predetermined event that has occurred and a load index indicating labor of monitoring work of a surveillant.

16. The monitoring method according to claim 15, further comprising:
calculating importance of monitoring of a predetermined event that has occurred in the monitoring target; and
updating, when the determined surveillant has performed the monitoring work, the load index of this surveillant in accordance with the importance of monitoring.

17. The monitoring method according to claim 16, comprising determining, when it has been determined that predetermined events have occurred in the plurality of monitoring targets, surveillants who are responsible for the monitoring work in a descending order of the importance of monitoring.

18. The monitoring method according to claim 16, wherein
the monitoring target is a mobile body, and
in the calculation of the importance of monitoring, the importance of monitoring is calculated in accordance with a number of passengers in the mobile body, a situation of the road on which the mobile body is traveling, or a combination thereof.

19. The monitoring method according to claim 15, wherein determining the surveillant who is responsible for the monitoring work comprises specifying one or more of the plurality of surveillants who can be responsible for work of monitoring the monitoring target where it has been determined that the predetermined event has occurred and determining a surveillant who is responsible for the monitoring work from among the one or more specified surveillants based on the predetermined event that has occurred and the load index.

20. The monitoring method according to claim 15, wherein determining the surveillant who is responsible for the monitoring work comprises determining a surveillant who is responsible for the monitoring work based on a handling ability of the surveillant of handling the predetermined event in the monitoring work.

21. (canceled)
